(19) United States
(12) Patent Application Publication
(10) Pub. No.: US 2018/0179464 A1
(43) Pub. Date: Jun. 28, 2018

(54) CARBON FIBER SURFACE OILING AGENT CHANGING METOD

(71) Applicant: UHT UNITECH CO., LTD, Taoyuan (TW)

(72) Inventor: CHIH-YUNG WANG, Taoyuan (TW)

(21) Appl. No.: 15/389,700

(22) Filed: Dec. 23, 2016

(51) Int. Cl. C10M 143/04; C10M 145/14; B05D 1/18; C10M 149/20; C10M 143/02; B05D 3/00

(52) U.S. Cl. CPC C10M 143/04; C10M 145/14; B05D 1/18; C10M 149/20; C10M 2205/022; B05D 3/007; C10M 2217/045; C10M 2205/024; C10M 2209/084; C10M 143/02

(57) ABSTRACT

A carbon fiber surface oiling agent changing method includes providing a raw material step; performing a desizing step; performing a plasma surface treatment step; and performing a sizing step. In the plasma surface treatment step, the impurities that originally adhere to the surface of the carbon fiber can be broken to form small molecules and blown away through the physical and chemical reaction of the plasma gas flow, enabling the surface of the carbon fiber to be roughened and provided with functional groups, which is beneficial to achieve high-quality interface bonding of the carbon fiber and the matrix resin in the subsequent sizing step, thereby enhancing the characteristics of carbon fiber composite materials.

### FIELD OF THE INVENTION

The present invention relates to a carbon fiber surface treatment technique, and more particularly to a carbon fiber surface oiling agent changing method which is capable of effectively changing the oiling agent on the surface of a carbon fiber.

### BACKGROUND OF THE INVENTION

Carbon fibers have excellent mechanical properties and electrical properties and can be widely used in various applications. A conventional carbon fiber is achieved by bundling precursor fibers, such as polyacrylonitrile fibers, to form a carbon fiber precursor fiber bundle, and then the carbon fiber precursor fiber bundle is calcined (high-temperature carbonization) to form the carbon fiber.

The surfaces of untreated carbon fibers don't have sufficient adhesion, which have poor transverse properties, such as separation strength and shear strength. Therefore, they are less directly utilized. They are usually combined with a matrix resin to form carbon fiber composite materials in accordance with their applications. On the other hand, because carbon fibers and graphite fibers are hard and brittle, they lack adhesion, bending and wear resistance. The surface of the carbon fiber or graphite fiber is always coated with a layer of oiling agent (a sizing agent) before it leaves the factory so as to protect the fiber from breakage due to friction.

In general, for using the excellent mechanical properties of carbon fibers, the matrix resin of the carbon fiber composite material is a thermosetting resin material to form the so-called thermosetting carbon fiber composite material. The main difference between the thermosetting carbon fiber composite material and the thermoplastic carbon fiber composite material is that the forming time of the traditional thermosetting carbon fiber composite material is long, resulting in lower utilization of the mold, so its production capacity is relatively low.

However, at present, most of the oiling agents on the surfaces of commercially available carbon fiber raw materials are thermosetting resin oiling agents designed according to the wettability of the thermosetting resin oiling agents. In case such carbon fiber raw materials are manufactured to form thermoplastic carbon fiber composite materials, the carbon fiber raw materials and the resin don't match with each to form a complete interface bonding. As a result, it cannot be applied to various kinds of electrical and electronic parts, mechanical parts and automobile parts which are formed by injection molding.

Accordingly, the inventor of the present invention has devoted himself based on his many years of practical experiences to solve these problems.

### SUMMARY OF THE INVENTION

In view of the problems of the prior art, the primary object of the present invention is to provide a carbon fiber surface oiling agent changing method.

In order to achieve the forgoing object, the carbon fiber surface oiling agent changing method of the present invention comprises: providing a raw material step, providing a carbon fiber, the carbon fiber being coated with a first oiling agent; performing a desizing step, the first oiling agent being removed; performing a plasma surface treatment step, providing a plasma gas flow to act on the carbon fiber; and performing a sizing step, a second oiling agent being coated on the carbon fiber.

Thereby, through the carbon fiber surface oiling agent changing method of the present invention, the oiling agent on the surface of the carbon fiber can be replaced with a desired oiling agent in a relatively more active and reliable manner. Particularly, through the plasma surface treatment, the surface of the carbon fiber is roughened and provided with functional groups, which is beneficial to achieve high-quality interface bonding of the carbon fiber and the desired oiling agent in the subsequent sizing step, thereby enhancing the characteristics of carbon fiber composite materials.

Preferably, in the plasma surface treatment step, the plasma gas flow with a power of 100-10000 watts acts on the carbon fiber for 10-1000 milliseconds.

Alternatively, in the plasma surface treatment step, an atmospheric plasma gas flow with a power of 100-10000 watts acts on the carbon fiber for 10-1000 milliseconds.

Alternatively, in the plasma surface treatment step, a low-pressure plasma gas flow with a power of 100-10000 watts acts on the carbon fiber for 10-1000 milliseconds.

Alternatively, in the plasma surface treatment step, a microwave plasma gas flow with a power of 100-10000 watts acts on the carbon fiber for 10-1000 milliseconds.

Alternatively, in the plasma surface treatment step, a glow plasma gas flow with a power of 100-10000 watts acts on the carbon fiber for 10-1000 milliseconds.

Preferably, the desizing step is performed at a temperature of 250-650° C. for 1-60 seconds.

Alternatively, the desizing step is performed by providing an organic solvent to remove the first oiling agent.

Preferably, the organic solvent is acetone or chloroform.

Preferably, in the sizing step, the second oiling agent is coated on the carbon fiber by soaking.

Alternatively, in the sizing step, the second oiling agent is coated on the carbon fiber by immersing.

Preferably, the first oiling agent is a thermosetting resin oiling agent.

Preferably, the second oiling agent is a thermosetting resin oiling agent.

Alternatively, the second oiling agent is a thermoplastic resin oiling agent.

Preferably, the second oiling agent is one of polyurethane (PU), polyethene (PE), polypropylene (PP), and acrylic.

Preferably, the carbon fiber surface oiling agent changing method further comprises a drying step after the sizing step, enabling the second oiling agent to be firmly adhered to the carbon fiber.

The carbon fiber surface oiling agent changing method of the present invention is suitable for replacing a thermosetting resin oiling agent on the surface of the existing carbon fiber raw material with a thermoplastic resin oiling agent so that it can be applied to various kinds of electrical and electronic parts, mechanical parts and automobile parts which are formed by injection molding. Particularly, the surface of the carbon fiber is roughened and is provided with functional groups, which is beneficial to achieve high-quality interface bonding of the carbon fiber and the thermoplastic resin oiling agent in the subsequent sizing step, thereby enhancing the characteristics of carbon fiber composite materials.

### BRIEF DESCRIPTION OF THE DRAWINGS

FIG. 1 is a flow diagram of a carbon fiber surface oiling agent changing method in accordance with a first embodiment of the present invention;

FIG. 2 is a sectional schematic view of a carbon fiber raw material in the step of providing a raw material in accordance with the carbon fiber surface oiling agent changing method the present invention;

FIG. 3 is a sectional schematic view of a carbon fiber after finishing a desizing step in accordance with the carbon fiber surface oiling agent changing method the present invention;

FIG. 4 is a sectional schematic view of a carbon fiber after finishing a plasma surface treatment step in accordance with the carbon fiber surface oiling agent changing method the present invention;

FIG. 5 is a sectional schematic view of a carbon fiber after finishing a sizing step in accordance with the carbon fiber surface oiling agent changing method the present invention; and

FIG. 6 is a flow diagram of a carbon fiber surface oiling agent changing method in accordance with a second embodiment of the present invention.

### DESCRIPTION OF THE PREFERRED EMBODIMENTS

Embodiments of the present invention will now be described, by way of example only, with reference to the accompanying drawings.

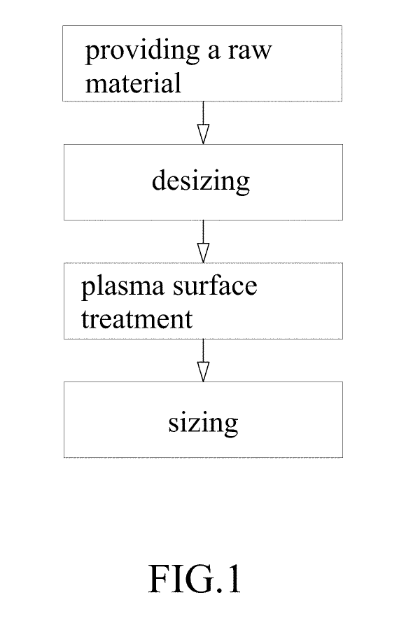

The present invention discloses a carbon fiber surface oiling agent changing method which is capable of effectively changing the oiling agent on the surface of a carbon fiber. As shown in FIG. 1, the carbon fiber surface oiling agent changing method of the present invention comprises providing a raw material step, performing a desizing step, performing a plasma surface treatment step, and performing a sizing step.

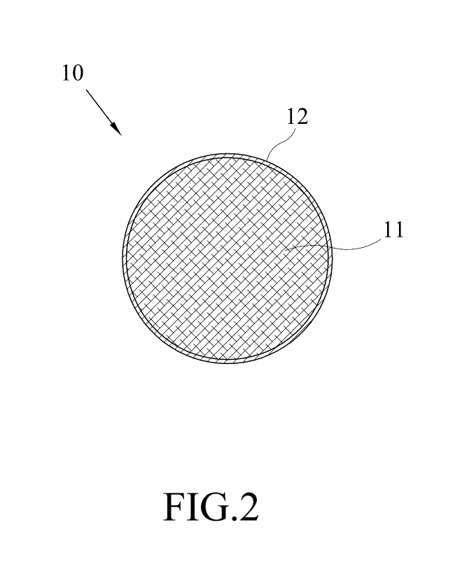

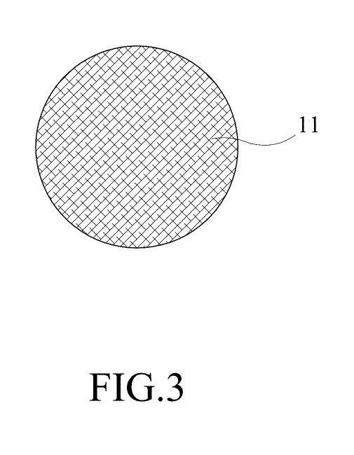

As shown in FIG. 1 to FIG. 5, the step of providing the raw material is to provide a carbon fiber raw material 10 formed of a carbon fiber 11 whose surface is coated with a first oiling agent 12. The carbon fiber 11 may be made of a carbon fiber precursor fiber bundle formed by bundling precursor fibers, such as rayon, poly vinyl alcohol, vinylidene chloride, polyacrylonitrile (PAN), pitch, and the like, obtained by calcination. In practice, the first oiling agent 12 may be a thermosetting resin oiling agent.

In the desizing step, the first oiling agent 12 is removed from the surface of the carbon fiber raw material 10. In practice, the desizing step may be performed at a temperature of 250-650° C. for 1-60 seconds, or by washing the surface of the carbon fiber raw material 10 with an organic solvent. In the embodiment by using the organic solvent to wash the surface of the carbon fiber raw material 10, the organic solvent may be acetone or chloroform.

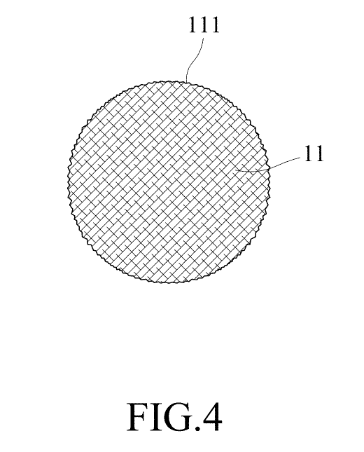

In the plasma surface treatment step, a plasma gas flow with a predetermined power is provided to act on the carbon fiber 11 without the first oiling agent, such that the surface of the carbon fiber 11 is formed with a plasma-modified configuration 111 (shown in FIG. 4) which is relatively rougher.

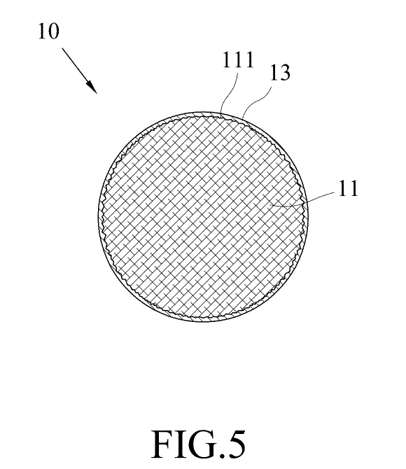

In the sizing step, the plasma-modified configuration 111 on the surface of the carbon fiber 11 is coated with a second oiling agent 13 to obtain the carbon fiber raw material 10 having the second oiling agent 13 thereon (as shown in FIG. 5). In practice, the second oiling agent 13 is coated on the surface of the carbon fiber 11 by soaking or immersing. The second oiling agent 13 may be a thermosetting resin oiling agent or a thermoplastic resin oiling agent. In an embodiment that the second oiling agent 13 is a thermoplastic resin oiling agent, the second oiling agent 13 may be one of polyurethane (PU), polyethene (PE), polypropylene (PP), and acrylic.

Thereby, through the carbon fiber surface oiling agent changing method of the present invention, the oiling agent on the surface of the carbon fiber can be replaced with a desired oiling agent in a relatively more active and reliable manner. Particularly, it is suitable for replacing a thermosetting resin oiling agent on the surface of the existing carbon fiber raw material with a thermoplastic resin oiling agent so that it can be applied to various kinds of electrical and electronic parts, mechanical parts and automobile parts which are formed by injection molding.

In the plasma surface treatment step, an atmospheric plasma gas flow, a low-pressure plasma gas flow, a microwave plasma gas flow, or a glow plasma gas flow with a power of 100-10000 watts may be used to act on the carbon fiber for 10-1000 milliseconds. Since the plasma gas flow contains particles having energy, the impurities that originally adhere to the surface of the carbon fiber can be broken to form small molecules and blown away through the physical reaction (collision) and chemical reaction of the plasma gas flow, enabling the surface of the carbon fiber to be roughened and provided with functional groups, which is beneficial to achieve high-quality interface bonding of the carbon fiber and the thermoplastic resin oiling agent in the subsequent sizing step, thereby enhancing the characteristics of carbon fiber composite materials.

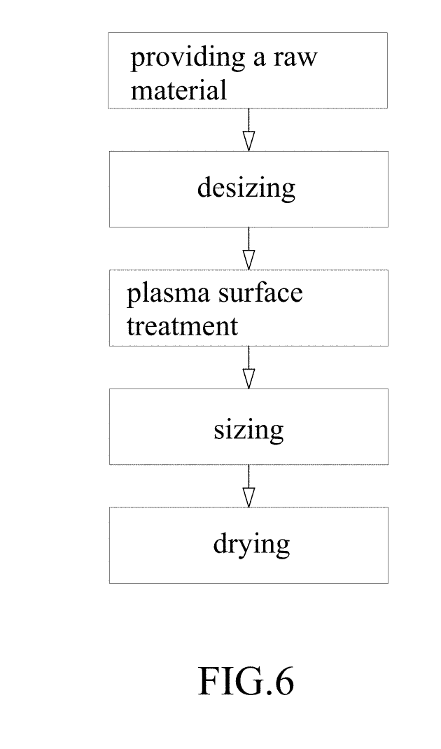

Furthermore, the plasma surface treatment of the present invention belongs to a dry-type surface treatment technique. This not only prevents the carbon fiber from generating additional impurities or sediment but also reduces the working time and working procedure of drying after the completion of the plasma surface treatment. As shown in FIG. 6, after the sizing step, the carbon fiber raw material having the second oiling agent is processed with at least one drying step, so that the second oiling agent is firmly adhered to the surface of the carbon fiber in a drying or wind-drying manner.

Specifically, the carbon fiber surface oiling agent changing method of the present invention is suitable for replacing a thermosetting resin oiling agent on the surface of the existing carbon fiber raw material with a thermoplastic resin oiling agent so that it can be applied to various kinds of electrical and electronic parts, mechanical parts and automobile parts which are formed by injection molding. Particularly, the surface of the carbon fiber is roughened and is provided with functional groups, which is beneficial to achieve high-quality interface bonding of the carbon fiber and the thermoplastic resin oiling agent in the subsequent sizing step, thereby enhancing the characteristics of carbon fiber composite materials.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A carbon fiber surface oiling agent changing method, comprising:
providing a raw material step, providing a carbon fiber, the carbon fiber being coated with a first oiling agent;
performing a desizing step, the first oiling agent being removed;
performing a plasma surface treatment step, providing a plasma gas flow to act on the carbon fiber; and
performing a sizing step, a second oiling agent being coated on the carbon fiber.

2. The carbon fiber surface oiling agent changing method as claimed in claim 1, wherein in the plasma surface treatment step, the plasma gas flow with a power of 100-10000 watts acts on the carbon fiber for 10-1000 milliseconds.

3. The carbon fiber surface oiling agent changing method as claimed in claim 1, wherein in the plasma surface treatment step, an atmospheric plasma gas flow with a power of 100-10000 watts acts on the carbon fiber for 10-1000 milliseconds.

4. The carbon fiber surface oiling agent changing method as claimed in claim 1, wherein in the plasma surface treatment step, a low-pressure plasma gas flow with a power of 100-10000 watts acts on the carbon fiber for 10-1000 milliseconds.

5. The carbon fiber surface oiling agent changing method as claimed in claim 1, wherein in the plasma surface treatment step, a microwave plasma gas flow with a power of 100-10000 watts acts on the carbon fiber for 10-1000 milliseconds.

6. The carbon fiber surface oiling agent changing method as claimed in claim 1, wherein in the plasma surface treatment step, a glow plasma gas flow with a power of 100-10000 watts acts on the carbon fiber for 10-1000 milliseconds.

7. The carbon fiber surface oiling agent changing method as claimed in claim 1, wherein the desizing step is performed at a temperature of 250-650° C. for 1-60 seconds.

8. The carbon fiber surface oiling agent changing method as claimed in claim 1, wherein the desizing step is performed by providing an organic solvent to remove the first oiling agent.

9. The carbon fiber surface oiling agent changing method as claimed in claim 8, wherein the organic solvent is acetone or chloroform.

10. The carbon fiber surface oiling agent changing method as claimed in claim 1, wherein in the sizing step, the second oiling agent is coated on the carbon fiber by soaking.

11. The carbon fiber surface oiling agent changing method as claimed in claim 1, wherein in the sizing step, the second oiling agent is coated on the carbon fiber by immersing.

12. The carbon fiber surface oiling agent changing method as claimed in claim 1, wherein the first oiling agent is a thermosetting resin oiling agent.

13. The carbon fiber surface oiling agent changing method as claimed in claim 1, wherein the second oiling agent is a thermosetting resin oiling agent.

14. The carbon fiber surface oiling agent changing method as claimed in claim 1, wherein the second oiling agent is a thermoplastic resin oiling agent.

15. The carbon fiber surface oiling agent changing method as claimed in claim 1, wherein the second oiling agent is one of polyurethane (PU), polyethene (PE), polypropylene (PP), and acrylic.

16. The carbon fiber surface oiling agent changing method as claimed in claim 1, further comprising a drying step after the sizing step, enabling the second oiling agent to be firmly adhered to the carbon fiber.
